(19) United States
(12) Patent Application Publication
(10) Pub. No.: US 2026/0099150 A1
(43) Pub. Date: Apr. 9, 2026

(54) DRONE, DRONE TRAINING METHOD, AND DRONE CONTROL METHOD

(71) Applicant: Wistron Corporation, New Taipei City (TW)

(72) Inventor: Chih Hung WU, New Taipei City (TW)

(21) Appl. No.: 19/010,574

(22) Filed: Jan. 6, 2025

(30) Foreign Application Priority Data
Oct. 8, 2024 (TW) 113138339

(51) Int. Cl. G05D 1/606; G05D 1/24; G05D 101/15; G05D 109/20; G05D 111/50

(52) U.S. Cl. CPC G05D 1/606; G05D 1/24; G05D 2101/15; G05D 2109/20; G05D 2111/56

(57) ABSTRACT

A drone training method includes: inputting a plurality of wind speed components into a corresponding plurality of fuzzy functions, to generate a plurality of wind speed membership values respectively; selecting one from the plurality of wind speed membership values corresponding to each of the wind speed components, and generating a rule value based on the wind speed membership values corresponding to each of the wind speed components; inputting the plurality of wind speed components into one of inference functions, where each rule value corresponds to one of the inference functions as a weight respectively, and calculating a function sum of a plurality of inference functions corresponding to each of the wind speed components; generating a regression model after calculating an error function base on each offset component and the function sum corresponding to each of the wind speed components and optimizing the error function.

### CROSS-REFERENCE TO RELATED APPLICATION

This non-provisional application claims priority under 35 U.S.C. § 119(a) to patent application No. 113138339 filed in Taiwan, R.O.C. on Oct. 8, 2024, the entire contents of which are hereby incorporated by reference.

### BACKGROUND

### Technical Field

The present invention relates to a drone technology, and in particular, to a drone capable of correcting a position offset and a method.

### Related Art

An application scope of drones is increasingly wide. From defense and military to aerial photography, from aerial photographing applications to patrol applications, and from public tasks to logistics transportation, drones gradually become an indispensable part of people's lives. However, during actual operation, drones often face challenges of various harsh environments, the most obvious of which is impact of wind. Wind not only affects steerability of a drone, but also affects flight stability. A sudden strong wind may even cause a flight accident.

### SUMMARY

In view of this, the applicant provides a drone training method, applicable to a drone. The drone includes a wind speed sensor and a position sensor. The drone training method includes: receiving a plurality of wind speed components generated by the wind speed sensor and a plurality of offset components generated by the position sensor, where the wind speed components correspond to the offset components one by one; inputting each of the wind speed components into a corresponding plurality of fuzzy functions, to generate a plurality of wind speed membership values respectively; selecting one from the plurality of wind speed membership values corresponding to each of the wind speed components, and generating a rule value based on the wind speed membership values corresponding to each of the wind speed components; inputting the plurality of wind speed components into inference functions, where each rule value corresponds to one of the inference functions as a weight respectively, and calculating a function sum of a plurality of inference functions corresponding to each of the wind speed components; and generating a regression model after calculating an error function base on each offset component and the function sum corresponding to each of the wind speed components and optimizing the error function.

The applicant further provides a drone, including a wind speed sensor, a position sensor, and a processor. The wind speed sensor is configured to measure a wind speed value, including a plurality of wind speed components. The position sensor is configured to measure an offset value, including a plurality of offset components. The processor is configured to perform the drone training method according to any embodiment of the present disclosure.

The applicant further provides a drone control method, for correcting a plurality of motor control signals. The drone control method includes: reading a plurality of wind speed components and a plurality of lookup tables, wherein each of the lookup tables corresponds to one of the motor control signals, and each of the plurality of lookup tables includes a regression model of a plurality of wind speed approximations and a compensation value; inputting each of the wind speed components into one of corresponding nearest neighbor functions, to generate the plurality of wind speed approximations; matching the plurality of wind speed approximations with the compensation values based on the corresponding lookup tables, to generate the compensation values; and correcting each of the motor control signals based on the compensation values generated by the lookup tables.

### BRIEF DESCRIPTION OF THE DRAWINGS

FIG. 1 is a schematic diagram of a drone known to the applicant being affected by an environmental wind.

FIG. 2 is a schematic block diagram of a drone according to some embodiments of the present disclosure.

FIG. 3 is a schematic diagram of a drone being affected by an environmental wind according to some embodiments of the present disclosure.

FIG. 4 is a flowchart of a drone control method according to some embodiments of the present disclosure.

FIG. 5 is a schematic diagram of signal transmission of a wind resistance controller according to some embodiments of the present disclosure.

FIG. 6 is a schematic diagram of a lookup table according to some embodiments of the present disclosure.

FIG. 7 is a schematic control flowchart of a drone control method according to some embodiments of the present disclosure.

FIG. 8 is a flowchart of a drone training method according to some embodiments of the present disclosure.

FIG. 9 is a schematic diagram of a model architecture of a regression model according to some embodiments of the present disclosure.

FIG. 10A is a schematic diagram of fuzzy functions of an X-axis wind speed component according to some embodiments of the present disclosure.

FIG. 10B is a schematic diagram of generating wind speed membership values by fuzzy functions of an X-axis wind speed component according to some embodiments of the present disclosure.

FIG. 11A is a schematic diagram of fuzzy functions of a Y-axis wind speed component according to some embodiments of the present disclosure.

FIG. 11B is a schematic diagram of generating wind speed membership values by fuzzy functions of a Y-axis wind speed component according to some embodiments of the present disclosure.

FIG. 12A is a schematic diagram of fuzzy functions of a Z-axis wind speed component according to some embodiments of the present disclosure.

FIG. 12B is a schematic diagram of generating wind speed membership values by fuzzy functions of a Z-axis wind speed component according to some embodiments of the present disclosure.

### DETAILED DESCRIPTION

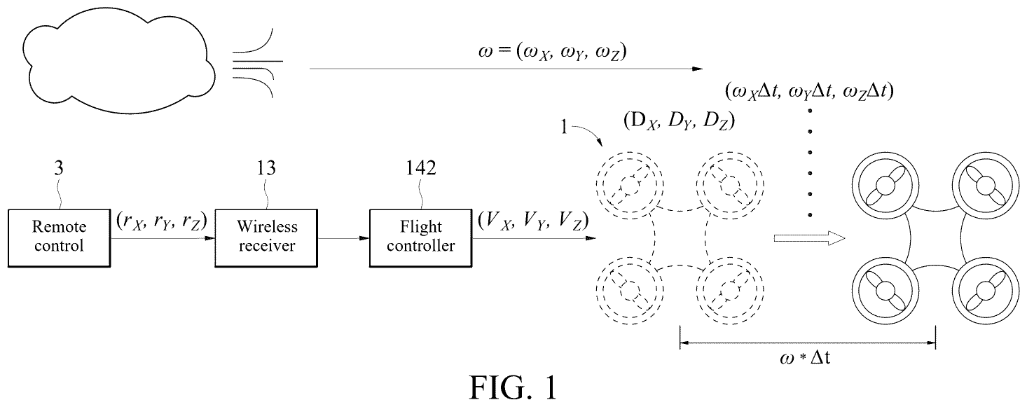

FIG. 1 is a schematic diagram of a drone known to the applicant being affected by an environmental wind. Referring to FIG. 1, a remote control 3 can be configured to set a destination position D_{X}, D_{Y}, D_{Z} of a drone 1, and transmit a displacement r_{X}, r_{Y}, r_{Z} to the drone 1 through a wireless signal. A wireless receiver 13 of the drone 1 receives the displacement r_{X}, r_{Y}, r_{Z} and transmits the displacement r_{X}, r_{Y}, r_{Z} to a flight controller 142. The flight controller 142 refers to the displacement r_{X}, r_{Y}, r_{Z} and generates a motor control signal correspondingly. The motor control signal may include a motor control signal component V_{X} in an X-axis direction, a motor control signal component V_{Y} in a Y-axis direction, and a motor control signal component V_{Z} in a Z-axis direction. A motor of the drone 1 drives the drone 1 to move to the destination position D_{X}, D_{Y}, D_{Z} in response to the motor control signal. FIG. 1 shows impact of wind on the drone 1. When an environmental wind with a wind speed value ω is generated in a flight environment of the drone 1. The wind speed value ω includes a wind speed component ω_{X} in the X-axis direction, a wind speed component ω_{Y} in the Y-axis direction, and a wind speed component ω_{Z} in the Z-axis direction. The wind speed components ω_{X}, ω_{Y}, and ω_{Z} cause the drone 1 to deviate from the original destination position D_{X}, D_{Y}, D_{Z} within a time difference Δt, and an offset value equals the wind speed value ω times the time difference Δt. An axis direction in the present disclosure may be an axis direction with the drone 1 as a coordinate center, an axis direction with the remote control 3 (or an operator) as a coordinate center, or an axis direction with a specified spatial position as a coordinate center. In this embodiment, the X-axis direction, the Y-axis direction, and the Z-axis direction are orthogonal to each other.

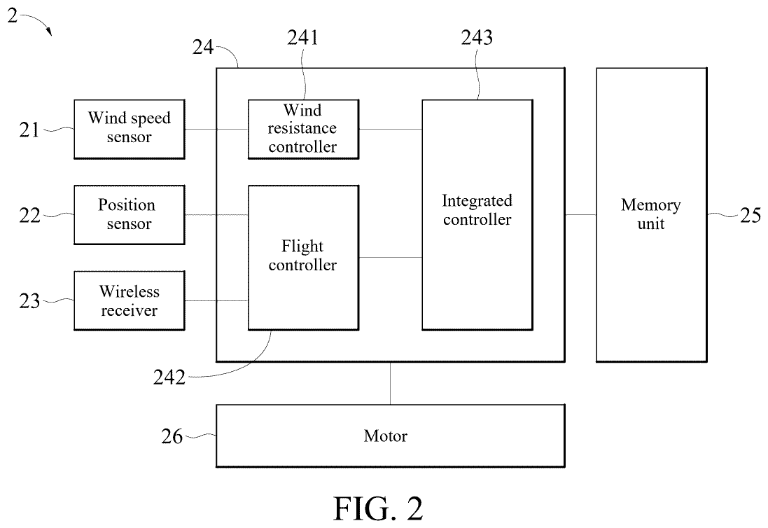

FIG. 2 is a schematic block diagram of a drone according to some embodiments of the present disclosure. Referring to FIG. 2, in this embodiment, a drone 2 includes a wind speed sensor 21, a position sensor 22, a wireless receiver 23, a processor 24, a memory unit 25, and a motor 26. The processor 24 is coupled to the wind speed sensor 21, the position sensor 22, the wireless receiver 23, the memory unit 25, and the motor 26 respectively. The wind speed sensor 21 is configured to measure a wind speed value ω of an environmental wind, and might divide the wind speed value ω into a plurality of wind speed components ω_{X}, ω_{Y}, and ω_{Z}. The wind speed sensor 21 may be a cup anemometer, a vane anemometer, a pressure tube anemometer, or an ultrasonic anemometer. The position sensor 22 is configured to measure absolute coordinates or relative coordinates of the drone 2, for example, determine the absolute coordinates of the drone 2 through a GPS locator or a barometer, or determine the relative coordinates of the drone 2 by measuring a relative offset value through an inertial measurement unit (IMU) such as a gyroscope or an accelerometer. The wireless receiver 23 is configured to receive a control instruction from the outside of the drone 2, for example, a wireless signal generated by the remote control 3, to learn of a destination position D_{X}, D_{Y}, D_{Z} set by an operator.

The processor 24 may be an SoC chip, a central processing unit (CPU), a microcontroller unit (MCU), an application-specific integrated circuit (ASIC), a field programmable gate array (FPGA), a neural network processor, a quantum processor, or a logic circuit. Referring to FIG. 2, in this embodiment, the processor 24 is configured to receive a control command or a measurement signal and generate a motor control signal to control the motor 26. Functions correspondingly implemented by the processor 24 may be divided into a wind resistance controller 241, a flight controller 242, and an integrated controller 243. Functions of the one or more controllers may be implemented by a single chip or a plurality of chips. The single chip forms the processor 24, or the plurality of chips jointly form the processor 24. In this embodiment, the drone 2 includes the processor 24, which may be configured to perform a drone control method and/or a drone training method according to any embodiment of the present disclosure.

The memory unit 25 may be a flash memory or a read-only memory (ROM), for example, an erasable programmable read-only memory (EPROM), a flash read-only memory (flash ROM), an electrically erasable programmable read-only memory (EEPROM), or a field-replaceable unit (FRU). In this embodiment, the memory unit 25 is configured to store the control command, the measurement signal, or the motor control signal. In some embodiments, the memory unit 25 may be configured to store program code, a lookup table T, or parameters of a drone control method and/or a drone training method according to any embodiment of the present disclosure.

The motor 26 adjusts a rotation speed according to the motor control signal. The motor control signal includes motor control signal components. The motor control signal components may correspond to a single motor 26 or a plurality of motors 26. When the motor control signal components correspond to a plurality of motors 26, rotation speeds generated by the different motors 26 in response to a same motor control signal component may be different. For example, for a four-axis drone, a motor control signal component V_{X} may correspond to all of four motors 26, and the four motors 26 adopt different rotation speeds to jointly move the four-axis drone in the X-axis direction. Alternatively, a motor control signal component V_{Z} may correspond to all of four motors 26, and the four motors 26 adopt a same rotation speed to jointly move the four-axis drone in the Z-axis direction.

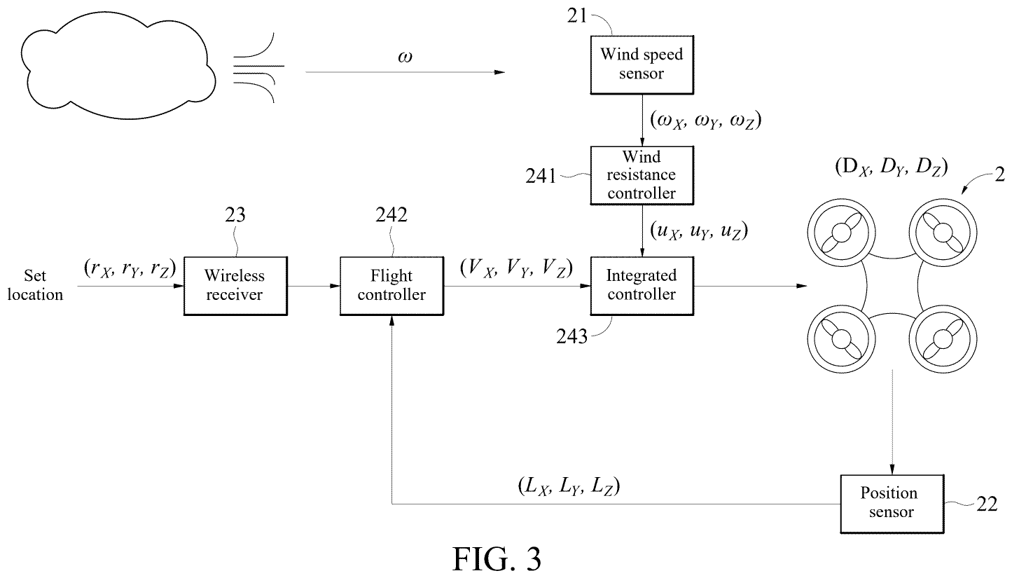

FIG. 3 is a schematic diagram of a drone being affected by an environmental wind according to some embodiments of the present disclosure. Referring to FIG. 2 and FIG. 3 together, in this embodiment, the processor 24 includes a wind resistance controller 241, a flight controller 242, and an integrated controller 243. The integrated controller 243 is coupled to the wind resistance controller 241 and the flight controller 242 respectively. The wind resistance controller 241 is coupled to the wind speed sensor 21. The flight controller 242 is coupled to the position sensor 22 and the wireless receiver 23. As shown in FIG. 3, the wireless receiver 23 of the drone 2 receives a displacement r_{X}, r_{Y}, r_{Z} and transmits the displacement r_{X}, r_{Y}, r_{Z} to the flight controller 242. The flight controller 242 refers to the displacement r_{X}, r_{Y}, r_{Z}, and generates a motor control signal component V_{X}, a motor control signal component V_{Y}, and a motor control signal component V_{Z} correspondingly. The motor 26 of the drone 2 drives the drone 2 to move to a destination position D_{X}, D_{Y}, D_{Z} in response to a motor control signal. In this embodiment, a flight environment generates an environmental wind with a wind speed value ω. The wind speed value ω is measured by the wind speed sensor 21 to generate a wind speed measurement signal including information about wind speed components ω_{X}, ω_{Y}, and ω_{Z}. The wind resistance controller 241 generates a compensation value, including compensation value components u_{X}, u_{Y}, and u_{Z}, corresponding to the wind speed measurement signal. The compensation value component u_{X} corresponds to the motor control signal component V_{X}, the compensation value component u_{Y} corresponds to the motor control signal component V_{Y}, and the compensation value component u_{Z} corresponds to the motor control signal component V_{Z}. The integrated controller 243 corrects the motor control signal according to the compensation value, so that an offset value caused by the environmental wind is offset. In this embodiment, the position sensor 22 of the drone 2 further transmits a position signal L_{X}, L_{Y}, L_{Z} of the drone 2 back to the flight controller 242, and the flight controller 242 determines a current relative position or absolute position of the drone 2 based on the position signal L_{X}, L_{Y}, L_{Z}, and adjusts the motor control signal based on the displacement r_{X}, r_{Y}, r_{Z} to drive the drone 2 to move to the destination position D_{X}, D_{Y}, D_{Z}.

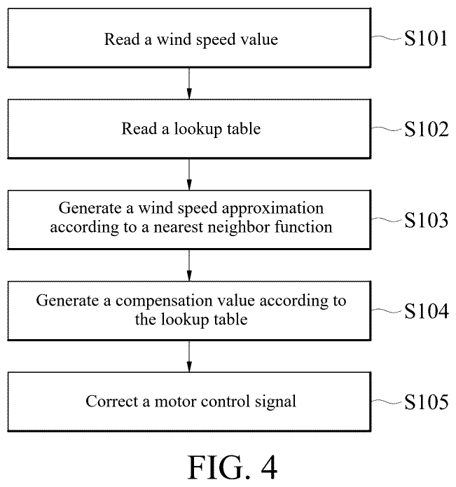

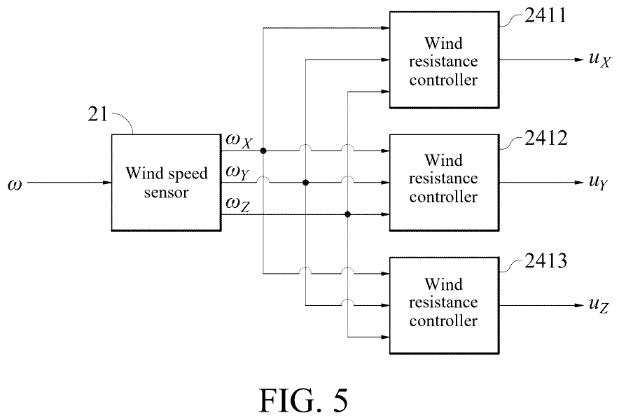

FIG. 4 is a flowchart of a drone control method according to some embodiments of the present disclosure. Referring to FIG. 4, in this embodiment, in the drone control method, a wind speed value w is read (step S101). For example, the processor 24 of the drone 2 performs the drone control method, and receives the wind speed value ω from the wind speed sensor 21. The wind speed value ω includes a plurality of wind speed components. In this embodiment, the wind speed value ω includes three wind speed components, that is, wind speed components ω_{X}, ω_{Y}, and ω_{Z}. FIG. 5 is a schematic diagram of signal transmission of a wind resistance controller according to some embodiments of the present disclosure. Referring to FIG. 5, in this embodiment, there are three wind resistance controllers 241 in total. A wind resistance controller 2411 corresponds to wind compensation in the X-axis direction, a wind resistance controller 2412 corresponds to wind compensation in the Y-axis direction, and a wind resistance controller 2413 corresponds to wind compensation in the Z-axis direction. The wind resistance controllers 2411, 2412, and 2413 respectively receive the wind speed components ω_{X}, ω_{Y}, and ω_{Z}, and generate compensation value components u_{X}, u_{Y}, and u_{Z} in specific axis directions to correct motor control signal components V_{X}, V_{Y}, and V_{Z} in the specific axis directions.

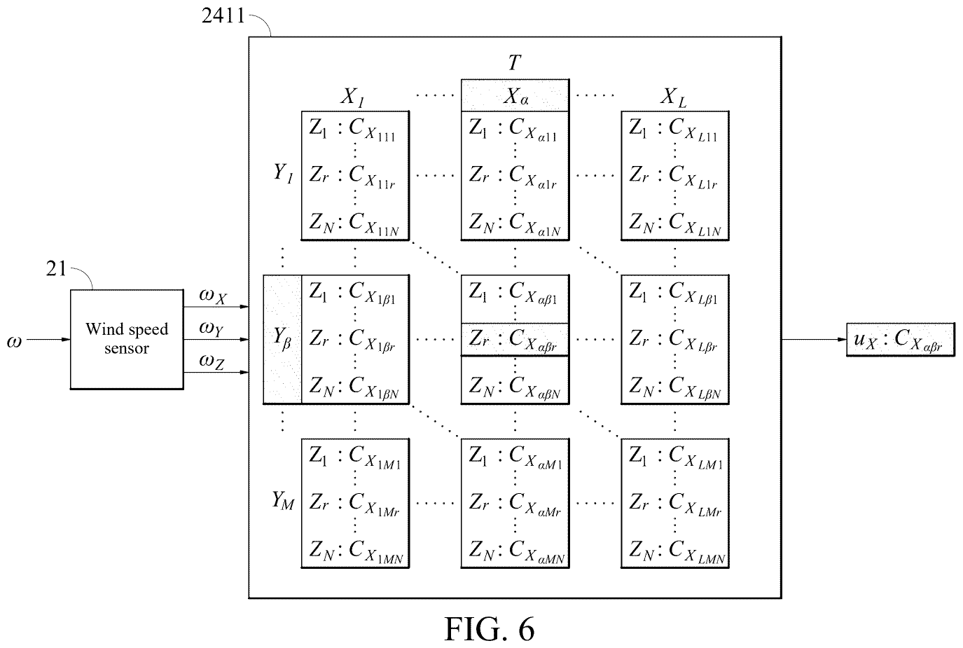

FIG. 6 is a schematic diagram of a lookup table according to some embodiments of the present disclosure. Referring to FIG. 4 to FIG. 6 together, specifically, the wind resistance controllers 241 read lookup tables T respectively (step S102). To be specific, the wind resistance controller 2411 reads the lookup table T in the X-axis direction, the wind resistance controller 2412 reads the lookup table T in the Y-axis direction, and the wind resistance controller 2413 reads the lookup table T in the Z-axis direction. In FIG. 6, the wind resistance controller 2411 is used as an example for description. In this embodiment, a lookup table T is a three-dimensional data structure. Columns of the lookup table T represent a total of L columns of data in the X-axis direction, rows thereof represent a total of M rows of data in the Y-axis direction, and layers thereof represent a total of N layers of data in the Z-axis direction. Each element stores a compensation value C_{X}. Therefore, the lookup table T read by the wind resistance controller 2411 in this embodiment includes a correspondence between three wind speed approximations and one compensation value C_{X}. In addition, the lookup table T read by the wind resistance controller 2412 and the lookup table T read by the wind resistance controller 2413 also include a correspondence between three wind speed approximations and one compensation value C_{Y} or compensation value C_{Z}, and the lookup tables T are different in content. Therefore, the wind resistance controllers 2411, 2412, and 2413 respectively generate the compensation value components u_{X}, the compensation value component u_{Y}, or the compensation value component u_{Z} in response to the same three wind speed components ω_{X}, ω_{Y}, and ω_{Z}.

One of the considerations for that the wind resistance controllers 241 respectively receive a plurality of wind speed components ω_{X}, ω_{Y}, and ω_{Z} to perform calculation is that because the drone 2 have different force-bearing areas and different force bearing angles, the three controllers are needed to calculate the compensation value components u_{X}, u_{Y}, and u_{Z} of the drone 2 for different axis directions respectively. Specifically, a housing of the drone 2 usually has slopes at different angles. Even if the environmental wind evenly blows the drone 2 along a specific axis direction, a wind direction of the environmental wind is not orthogonal to all the slopes. Such a phenomenon makes it impossible to calculate compensation of the drone 2 for wind simply from a single direction. Because when a body of the drone 2 is blown, normal forces in different directions generated by wind on the drone 2 partially twist the body of the drone 2, resulting in a control failure. Therefore, in this embodiment, the drone 2 uses the wind resistance controllers 2411, 2412, and 2413 with inputs in three directions to compensate for the three wind speed components ω_{X}, ω_{Y}, and ω_{Z}.

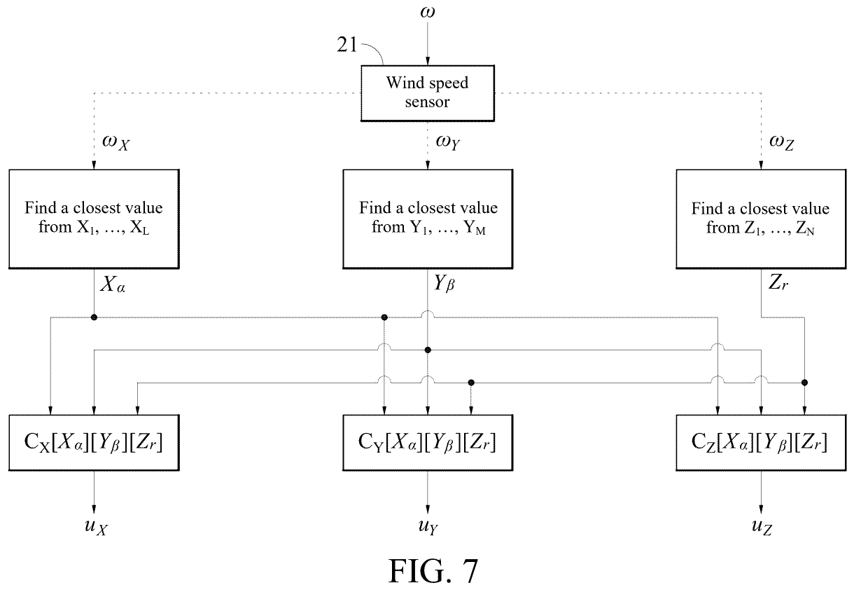

FIG. 7 is a schematic control flowchart of a drone control method according to some embodiments of the present disclosure. Referring to FIG. 4 and FIG. 7 together, after the wind speed value ω is read (step S101), in the drone control method, a wind speed approximation is generated according to a nearest neighbor function (step S103). The nearest neighbor function performs regression according to a value of wind speed component to generate a specific value closest to the value of the wind speed component by using, for example, but not limited to, a rounding function, a bottoming function, a ceiling function, or a shortest distance method. Specifically, in some embodiments, the nearest neighbor function includes a plurality of discrete wind speed component values. In the drone control method, one discrete wind speed component value in the plurality of discrete wind speed component values closest to the wind speed component input into the nearest neighbor function is determined, to generate a wind speed approximation. For example, the nearest neighbor function includes discrete wind speed component values [−1.1, 0, 1.1, 2.2, 3.3, 4.4]. When a wind speed component ω_{X} with a value of 3 is input into the nearest neighbor function, and a compensation value with a value of 3.3 is generated by using the shortest distance method. In another embodiment, the nearest neighbor function includes discrete wind speed component values [−3, −2, −1, 0, 1, 2, 3]. When a wind speed component ω_{X} with a value of 1.4 is input into the nearest neighbor function, and a compensation value with a value of 1 is generated by rounding off. The wind speed components each correspond to a nearest neighbor function, and the nearest neighbor functions may be the same or different.

The discrete wind speed component values may be defined by taking a wind speed component range to which the drone 2 is subject into consideration. The wind speed component range may be defined manually or measured by using the wind speed sensor 21 during use of the drone 2. In some embodiments, the drone 2 collects statistics on a wind speed component range according to a plurality of wind speed components generated by the wind speed sensor 21. For example, the wind speed component range may be defined by taking maximum and minimum wind speed components to which the drone 2 is subject in different axis directions in a test scenario into consideration. In the embodiment of FIG. 6, a maximum wind speed component value in the Y-axis direction defined in the lookup table T is a value of a row Y_{M}, a minimum wind speed component value is a value of a row Y₁, and a wind speed component range defined by the two values is evenly divided to generate a total of M discrete wind speed component values. Alternatively, the wind speed component range is defined based on multiples of average wind speed components to which the drone 2 is subject in different axis directions plus or minus their standard deviations.

After obtaining wind speed approximations, in the drone control method, compensation values C_{X}, C_{Y}, and C_{Z} are generated according to the lookup table T (step S104), and the motor control signal is corrected using the compensation values C_{X}, C_{Y}, and C_{Z} (step S105). As shown in FIG. 7, the nearest neighbor functions of the three axis directions respectively generate a wind speed approximation X_{α}, a wind speed approximation Y_{β}, and a wind speed approximation Z_{γ}. The processor 24 performs matching based on the same three wind speed approximations in a lookup table T applicable to each axis direction to generate compensation values C_{X}, C_{Y}, and C_{Z}. Therefore, in the drone control method, in a processing mode of the lookup table T, the compensation values C_{X}, C_{Y}, and C_{Z} can be quickly generated corresponding to different wind speed conditions by performing only numerical comparison, and in response to an instantaneous wind change, a position offset caused by the instantaneous wind change to the drone 2 can be offset. In addition, a computing amount of the processor 24 is reduced, power consumption is greatly reduced, and a flight time of the drone 2 is extended.

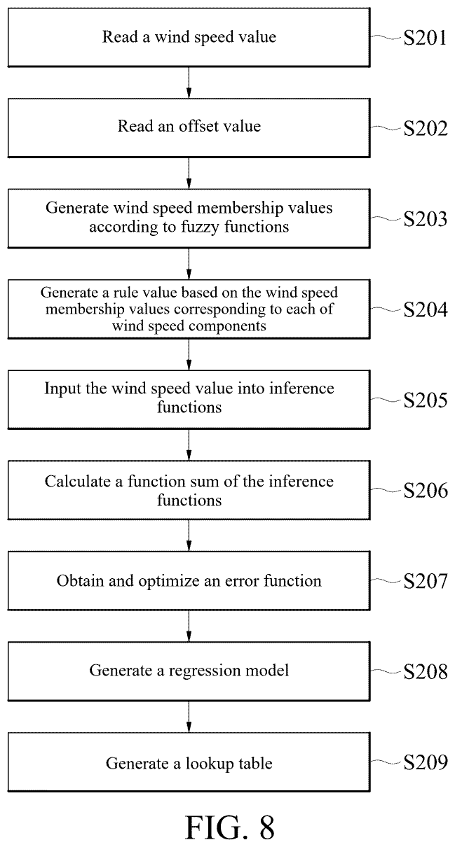

FIG. 8 is a flowchart of a drone training method according to some embodiments of the present disclosure. Referring to FIG. 8, in this embodiment, in the drone training method, a wind speed value ω is read (step S201). For example, the processor 24 of the drone 2 performs the drone training method, and receives the wind speed value ω from the wind speed sensor 21 after controlling the drone 2 to take off and setting the drone 2 to a hovering state. In some other embodiments, the processor 24 of the drone 2 controls the drone 2 to take off and sets the drone 2 to fly at a fixed speed or a fixed acceleration, and receives the wind speed value ω from the wind speed sensor 21. The wind speed value ω includes a plurality of wind speed components. In this embodiment, the wind speed value ω includes three wind speed components, that is, wind speed components ω_{X}, ω_{Y}, and ω_{Z}. In addition, in the drone training method, an offset value is read (step S202). As shown in FIG. 1, an environmental wind with the wind speed value ω causes the drone 1 to deviate from an original destination position D_{X}, D_{Y}, D_{Z}, and an offset value is equivalent to a distance difference between an actual position of the drone 1 and a destination position D_{X}, D_{Y}, D_{Z}. In some embodiments, the drone 2 has a position sensor 22 to measure an offset value. The offset value includes a plurality of offset components. In this embodiment, the offset value includes three offset components, respectively corresponding to offsets caused by the wind speed components ω_{X}, ω_{Y}, and ω_{Z}. For example, after an operator lifts off the drone 2, the wind speed sensor 21 of the drone 2 records the wind speed components ω_{X}, ω_{Y}, and ω_{Z}, and the position sensor 22 records corresponding offset components.

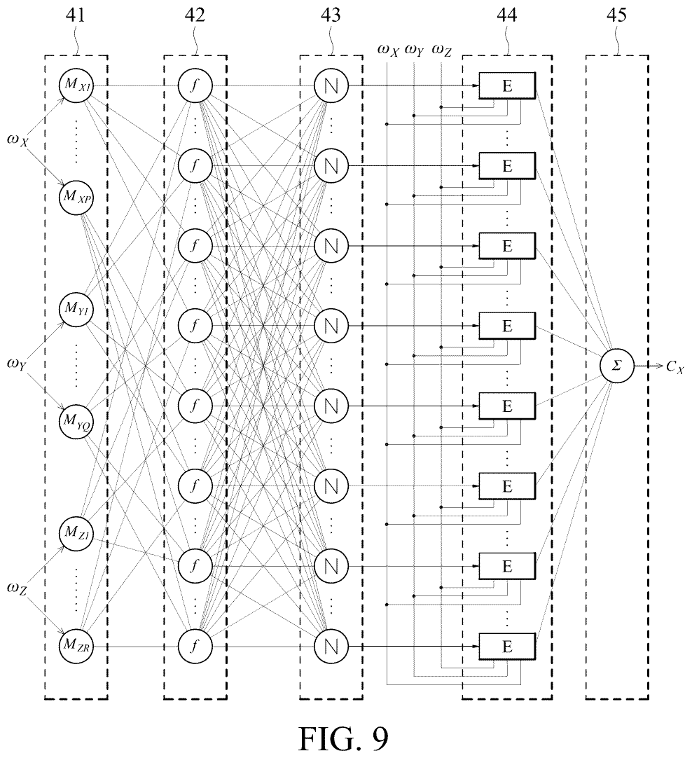

FIG. 9 is a schematic diagram of a model architecture of a regression model according to some embodiments of the present disclosure. Referring to FIG. 9, in this embodiment, the regression model is implemented by a neural network. The neural network includes an input layer 41, a rule layer 42, a normalization layer 43, an inference layer 44, and an output layer 45. In this embodiment, the input layer 41, the rule layer 42, the normalization layer 43, and the inference layer 44 each include a plurality of nodes, and the output layer 45 includes a single node. The plurality of nodes of the input layer 41 are respectively coupled to the plurality of nodes of the rule layer 42. The plurality of nodes of the rule layer 42 are respectively coupled to the plurality of nodes of the normalization layer 43. The plurality of nodes of the normalization layer 43 are coupled to the plurality of nodes of the inference layer 44 one-to-one. The plurality of nodes of the inference layer 44 are coupled to the single node of the output layer 45.

Referring to FIG. 8 and FIG. 9 together, in this embodiment, in the drone training method, each of the wind speed components is input into a corresponding plurality of fuzzy functions, and wind speed membership values are generated according to fuzzy functions (step S203). As shown in FIG. 9, a wind speed component ω_{X} is correspondingly input into a plurality of nodes in the input layer 41, and the nodes are represented by a fuzzy function M_{X1} to a fuzzy function M_{XP} (a total of P nodes). A wind speed component ω_{Y} is correspondingly input into another group of a plurality of nodes in the input layer 41, and the nodes are represented by a fuzzy function M_{Y1} to a fuzzy function M_{YQ} (a total of Q nodes). A wind speed component ω_{Z} is correspondingly input into a remaining plurality of nodes in the input layer 41, and the nodes are represented by a fuzzy function M_{Z1} to a fuzzy function M_{ZR} (a total of R nodes).

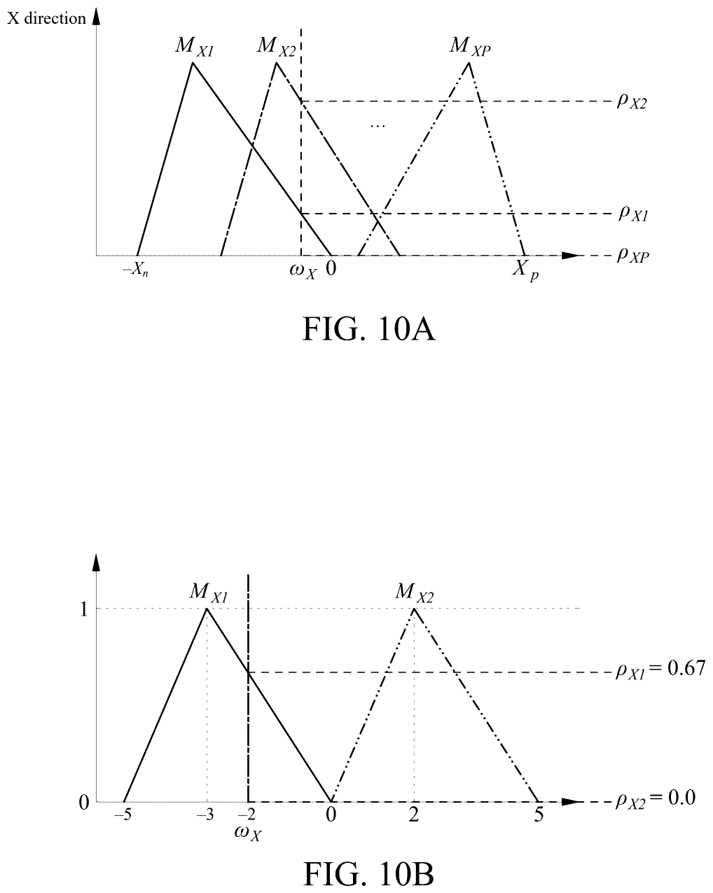

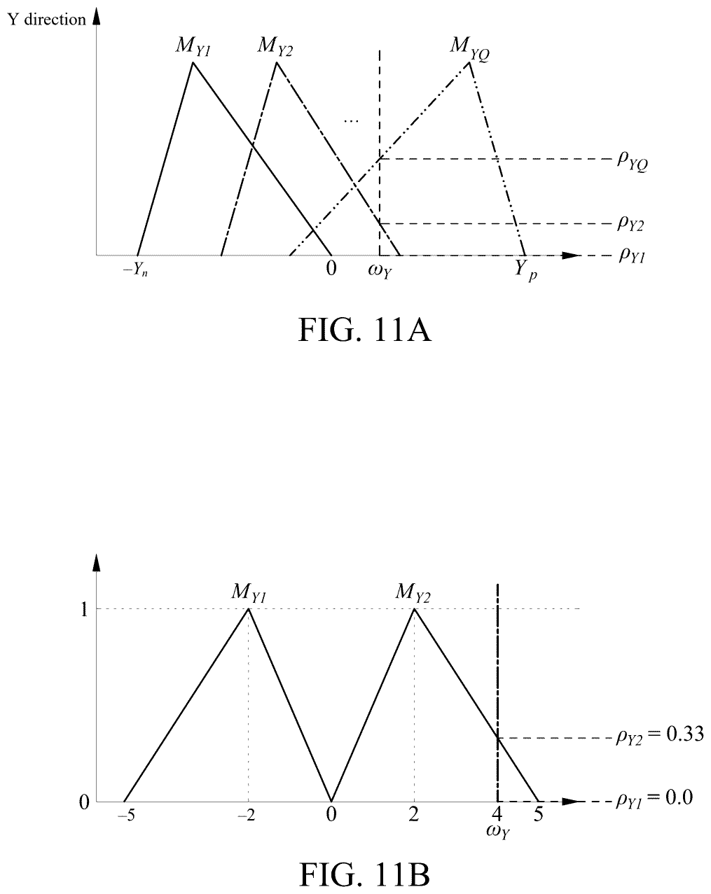

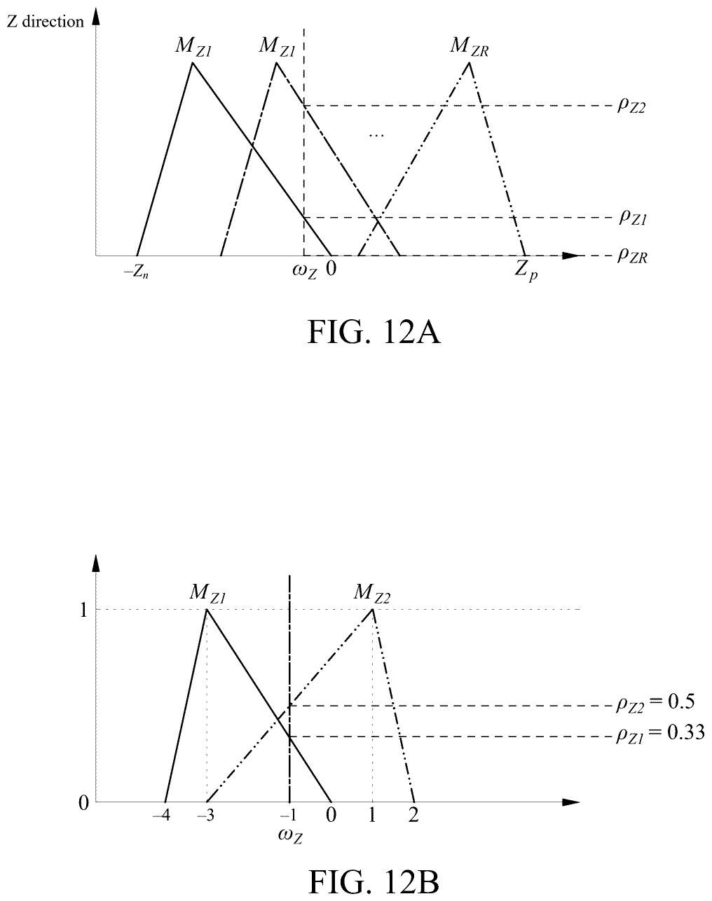

FIG. 10A is a schematic diagram of fuzzy functions of an X-axis wind speed component according to some embodiments of the present disclosure. FIG. 11A is a schematic diagram of fuzzy functions of a Y-axis wind speed component according to some embodiments of the present disclosure. FIG. 12A is a schematic diagram of fuzzy functions of a Z-axis wind speed component according to some embodiments of the present disclosure. Referring to FIG. 10A, FIG. 11A, and FIG. 12A together, in the schematic diagrams for reference, a horizontal axis represents a wind speed value ω, and a vertical axis represents a membership degree. Using FIG. 10A as an example, a total of P fuzzy functions M_{X} are included (FIG. 10A shows only three of the P fuzzy functions M_{X}). In this embodiment, each fuzzy function M_{X} is represented by a triangle, and a membership degree of a vertex thereof (that is, a core of the fuzzy function M_{X}) is 1. For the fuzzy function M_{X1}, when the wind speed value ω ranges from −Xₙ to 0, and a membership degree thereof is greater than 0. In this embodiment, when the wind speed component ω_{X} is correspondingly input into a plurality of nodes in the input layer 41, a node corresponding to the fuzzy function M_{X1} generates a membership value ρ_{X1}, a node corresponding to the fuzzy function M_{X2} generates a membership value ρ_{X2}, and a node corresponding to the fuzzy function M_{YP} generates a membership value ρ_{XP}. Similarly, when the wind speed component ω_{Y} is correspondingly input into another group of a plurality of nodes in the input layer 41, a node corresponding to the fuzzy function M_{Y1} generates a membership value ρ_{Y1}, a node corresponding to the fuzzy function M_{Y2} generates a membership value ρ_{Y2}, and a node corresponding to the fuzzy function M_{YQ} generates a membership value ρ_{YQ}. Likewise, when the wind speed component ω_{Z} is correspondingly input into a remaining plurality of nodes in the input layer 41, a node corresponding to the fuzzy function M_{Z1} generates a membership value ρ_{Z1}, a node corresponding to the fuzzy function M_{Z2} generates a membership value ρ_{Z2}, and a node corresponding to the fuzzy function M_{ZR} generates a membership value ρ_{ZR}.

FIG. 10B is a schematic diagram of generating wind speed membership values by fuzzy functions of an X-axis wind speed component according to some embodiments of the present disclosure. FIG. 11B is a schematic diagram of generating wind speed membership values by fuzzy functions of a Y-axis wind speed component according to some embodiments of the present disclosure. FIG. 12B is a schematic diagram of generating wind speed membership values by fuzzy functions of a Z-axis wind speed component according to some embodiments of the present disclosure. Referring to FIG. 10B, FIG. 11B, and FIG. 12B together, for example, when the wind speed component ω_{X} is −2, the wind speed component ω_{Y} is 4, and the wind speed component ω_{Z} is −1, the wind speed components ω_{X}, ω_{Y}, and ω_{Z} are input into the neural network. As shown in FIG. 10B, the wind speed component ω_{X}=−2 is input into the fuzzy function M_{X1}, and a generated membership value ρ_{X1} is 0.67. Because a range of the wind speed value ω of the fuzzy function M_{X2} does not cover −2, a generated membership value ρ_{X2} is 0, and the same applies to the remaining fuzzy functions M_{X}. As shown in FIG. 11B, the wind speed component ω_{Y}=4 is input into the fuzzy function M_{Y1}. Because a range of the wind speed value ω of the fuzzy function M_{Y1} does not cover 4, a generated membership value ρ_{Y1} is 0. A generated membership value ρ_{Y2} of the fuzzy function M_{Y2} is 0.33, and the same applies to the remaining fuzzy functions M_{Y}. As shown in FIG. 12B, the wind speed component ω_{Z}=−1 is input into the fuzzy function M_{Z1}, a generated membership value ρ_{Z1} is 0.33, a generated membership value ρ_{Z2} of the fuzzy function M_{Z2} is 0.5, and the same applies to the remaining fuzzy functions M_{Z}. Therefore, when the wind speed components ω_{X}, ω_{Y}, and ω_{Z} are input into the neural network, a plurality of wind speed membership values are generated respectively.

In some embodiments, in the drone training method, the plurality of fuzzy functions at equal core intervals are generated within a wind speed component range. For example, referring to FIG. 10A, in the X-axis direction, a wind speed value ω at a lower limit of the wind speed component range is −Xₙ, and a wind speed value ω at an upper limit of the wind speed component range is Xₚ. An interval between a core of the fuzzy function M_{X1} and a core of the fuzzy function M_{X2} equals an interval between the core of the fuzzy function M_{X2} and a core of the fuzzy function M_{X3}, also equals an interval between the core of the fuzzy function M_{X3} and a core of the fuzzy function M_{X4}, also equals an interval between a core of the fuzzy function M_{XP-1} and a core of the fuzzy function M_{XP}, and so on. Therefore, a distribution of the fuzzy functions is dispersed in each wind speed component range, so that a distribution of the membership values is evenly dispersed. In some embodiments, the wind speed component ranges define a wind range that the drone 2 can withstand, or extreme or average upper and lower limit wind ranges actually measured.

Referring to FIG. 8 and FIG. 9, in the drone training method, one of the plurality of wind speed membership values corresponding to each of the wind speed components is selected to obtain the wind speed membership value, and a rule value is generated according to the wind speed membership values corresponding to the each of wind speed components (step S204). As shown in FIG. 9, the rule layer 42 receives the membership values generated by the input layer 41 to generate a rule value. For example, the input layer 41 generates a membership value ρ_{X1}, a membership value ρ_{X2}, . . . , and a membership value ρ_{XP}. The membership values correspond to the wind speed component ω_{X}. In the drone training method, a single one, for example, the membership value ρ_{X1}, is selected from them. The input layer 41 generates a membership value ρ_{Y1}, a membership value ρ_{Y2}, . . . , and a membership value ρ_{YQ}. The membership values correspond to the wind speed component ω_{Y}. In the drone training method, a single one, for example, the membership value ρ_{Y1}, is selected from them. The input layer 41 generates a membership value ρ_{Z1}, a membership value ρ_{Z2}, . . . , and a membership value ρ_{ZR}. The membership values correspond to the wind speed component ω_{Z}. In the drone training method, a single one, for example, the membership value ρ_{Z1}, is selected from them. In the drone training method, a rule value win is generated based on the membership value ρ_{X1}, the membership value ρ_{Y1}, and the membership value ρ_{Z1}. In another example, in the drone training method, a rule value ω₂₁₁ is generated based on the membership value ρ_{X2}, the membership value ρ_{Y1}, and the membership value ρ_{Z1}. Therefore, in the drone training method, a rule value w_{PQR} is generated based on the membership value ρ_{XP}, the membership value ρ_{YQ}, and the membership value ρ_{ZR}, and P×Q×R rule values are generated in total.

In some embodiments, in the drone training method, a minimum value among the wind speed membership values corresponding to all the wind speed components is used as the rule value. For example, referring to FIG. 10B, FIG. 11B, and FIG. 12B, if the membership value ρ_{X1} is 0.67, the membership value ρ_{Y1} is 0, and the membership value ρ_{Z1} is 0.33, in the drone training method, a rule value ω₁₁₁ obtained based on a minimum value among the membership values is 0. If the membership value ρ_{X1} is 0.67, the membership value ρ_{Y2} is 0.33, and the membership value ρ_{Z2} is 0.5, in the drone training method, a rule value ω₁₂₂ obtained based on a minimum value among the membership values is 0.33. In some other embodiments, in the drone training method, an accumulated product of the wind speed membership values corresponding to all the wind speed components is used as the rule value. For example, if the membership value ρ_{X1} is 0.67, the membership value ρ_{Y1} is 0, and the membership value ρ_{Z1} is 0.33, in the drone training method, a rule value w₁₁₁ obtained based on an accumulated product of the membership values is 0. If the membership value ρ_{X1} is 0.67, the membership value ρ_{Y2} is 0.33, and the membership value ρ_{Z2} is 0.5, in the drone training method, a rule value ω₁₂₂ obtained based on an accumulated product of the membership values is 0.11055.

In some embodiments, in the drone training method, the rule values are divided by a sum of all the rule values, to normalize the rule values. Referring to FIG. 9, in this embodiment, each node of the normalization layer 43 receives rule values output from all the nodes of the rule layer 42. The nodes of the normalization layer 43 calculate normalized rule values according to the following Formula 1:

$$\overline{{w}_{ijk}} = \frac{{w}_{ijk}}{{\sum }_{x = 1}^{P} {\sum }_{y = 1}^{Q} {\sum }_{z = 1}^{R} {w}_{xyz}} \qquad ( Formula 1 )$$

where i, j, and k are numbers of rule values, and P is a total number of rule values corresponding the wind speed component ω_{X}, Q is a total number of rule values corresponding the wind speed component ω_{Y}, and R is a total number of rule values corresponding the wind speed component ω_{Z}. For example, assuming that P, Q, and R are all respectively 2, and rule values are w₁₁₁=0, w₁₁₂=0, w₁₂₁=0.33, w₁₂₂=0.33, w₂₁₁=0, w₂₁₂=0, w₂₂₁=0, and w₂₂₂=0, normalized rule values obtained based on the formula 1 are w̅₁̅₁̅₁̅=0, w̅₁̅₁̅₂̅=0, w̅₁̅₂̅₁̅=0.5, w̅₁̅₂̅₂̅=0.5, w̅₂̅₁̅₁̅=0, w̅₂̅₁̅₂̅=0, w̅₂̅₂̅₁̅=0, and w̅₂̅₂̅₂̅=0.

The nodes in the inference layer 44 receive the rule values or the normalized rule values as weights for the inference functions E. For example, referring to FIG. 9, the inference layer 44 includes nodes whose quantity is the same as that of the nodes of the normalization layer 43. Each node in the inference layer 44 separately receives a normalized weight value output from one node of the normalization layer 43, and uses the normalized weight value as a weight for the inference function E. In addition, the nodes in the inference layer 44 separately receive the wind speed components ω_{X}, ω_{Y}, and ω_{Z}, to input the wind speed value ω into the inference functions E (step S205). In some embodiments, the inference function E is a multivariate linear regression model function, including N regression coefficients and a bias value, where a value of N equals a quantity of the plurality of wind speed components. For example, the inference function E may be represented by the following Formula 2:

$$E ( {ω}_{X} , {ω}_{Y} , {ω}_{Z} ) = \overline{{w}_{ijk}} {f}_{ijk} = \overline{{w}_{ijk}} ( {p}_{ijk} {ω}_{X} + {q}_{ijk} {ω}_{Y} + {r}_{ijk} {ω}_{Z} + {s}_{ijk} ) \qquad ( Formula 2 )$$

where w̅ᵢ̅ⱼ̅ₖ̅ is a rule value or a normalized rule value, pᵢⱼₖ, qᵢⱼₖ, and rᵢⱼₖ are regression coefficients, and sᵢⱼₖ is a bias value. In this embodiment, there are three wind speed components ω_{X}, ω_{Y}, and ω_{Z}, so that the inference function E includes three regression coefficients. For example, when the wind speed component ω_{X} is −2, the wind speed component ω_{Y} is 4, the wind speed component ω_{Z} is −1, and a normalized rule value w̅₁̅₂̅₁̅ is 0.5, the inference function E (−2, 4, −1) is represented by 0.5×(−2pᵢⱼₖ+4qᵢⱼₖ−rᵢⱼₖ+sᵢⱼₖ). In this embodiment, the regression coefficients and the bias value may be learned through an iterative process, which is described below in detail.

In the drone training method, a function sum of the inference functions E is calculated (step S206). For example, referring to FIG. 9, a node of the output layer 45 receives the inference functions E output from all the nodes of the inference layer 44. The output layer 45 obtains a function sum of a plurality of inference functions E. The function sum corresponds to the wind speed component ω_{X}. The function sum may be represented by the following Formula 3:

$$C = {\sum }_{i = 1}^{P} {\sum }_{j = 1}^{Q} {\sum }_{k = 1}^{R} {E}_{ijk} \qquad ( Formula 3 )$$

where E is an inference function, and Cis a function sum corresponding to a wind speed component. Then, in the drone training method, an error function is obtained and optimized (step S207). Specifically, in the drone training method, an error function between each offset component and a function sum corresponding to the wind speed component is calculated. In some embodiments, the error function may be represented by the following Formula 4:

$$e = \frac{1}{2} {( U - C )}^{2} \qquad ( Formula 4 )$$

where e is an error function corresponding to one of wind speed components, U is an offset component corresponding to the one of the wind speed components, and Cis a function sum corresponding to the one of the wind speed components. In this way, an input of the regression model is wind speed components ω_{X}, ω_{Y}, and ω_{Z}, and an output thereof is an offset component corresponding to one of the wind speed components ω_{X}, ω_{Y}, and ω_{Z}, that is, the corresponding wind speed component ω_{X} in this embodiment. In some embodiments, in the drone training method, an offset component is taken as a negative number, and the offset component that is taken as a negative number is used as an output of the regression model, to correspond to a wind speed component in a same axis direction. Specifically, as shown in FIG. 1 and FIG. 3, an environmental wind causes a position offset of the drone, and the position sensor 22 of the drone 2 may measure an offset value caused by the environmental wind. To compensate for offset value components, the drone 2 needs to generate compensation value components u_{X}, u_{Y}, and u_{Z} to offset impact caused by the environmental wind. Directions of the offset value components are opposite to directions of the compensation value components u_{X}, u_{Y}, and u_{Z}.

In the drone training method, an optimization problem of an error function is calculated. For example, a minimum value, that is, min_{θ}(1/2(U−C)²), of an error function e is calculated, to optimize a model parameter θ of the regression model, for example, a regression coefficient or a bias value of an inference function E, a function type of fuzzy functions M_{X}, M_{Y}, and M_{Z}, a core position, or positions of left and right endpoints. In the foregoing optimization problem, the model parameter θ may be obtained through a gradient descent method, which is represented by the following Formula 5:

$${θ}_{[ k + 1 ]} = {θ}_{[ k ]} - η * \frac{\partial e}{\partial {θ}_{[ k ]}} \qquad ( Formula 5 )$$

where k is an iteration order, θ is a model parameter corresponding to one of the wind speed components, and η is a learning rate. Therefore, in this embodiment, in the drone training method, model parameters θ of the regression model are obtained through an optimization iterative process, to generate the regression model (step S208). FIG. 9 illustrates a regression model corresponding to the wind speed component ω_{X}. Similarly, in the drone training method, regression models corresponding to the wind speed components can be respectively trained based on offset values corresponding to the wind speed components as model outputs. As shown in FIG. 2, in some embodiments, model parameters θ of the regression models are stored in the memory unit 25, the drone 2 may generate compensation values C_{X}, C_{Y}, and C_{Z} through the regression models, to offset impact of wind on the drone 2.

In some embodiments, after the regression models are generated in the drone training method, the drone 2 is set to the hovering mode again (which may also be a fixed speed mode or a fixed acceleration mode), and the compensation values C_{X}, C_{Y}, and C_{Z} are generated through the regression models, to offset impact of wind on the drone 2. In this case, the drone 2 may perform step S201 to step S208 again. Specifically, the drone 2 receives wind speed components generated by the wind speed sensor 21 again (step 201), and inputs the wind speed components into regression models to generate a plurality of compensation values C_{X}, C_{Y}, and C_{Z}. After the drone 2 corrects motor control signals respectively based on the plurality of compensation values C_{X}, C_{Y}, and C_{Z}, the drone 2 is controlled to hover (or fly at a fixed speed or a fixed acceleration) using the plurality of corrected motor control signals, and receives an offset value generated by the position sensor 22 again (step 202). Therefore, the drone 2 may retrain the regression models according to the wind speed components and the offset value, to optimize a wind resistance control capability of the drone 2.

In some embodiments, in the drone training method, a lookup table T is generated according to the regression models (step S209), and the lookup table T may be stored in the memory unit 25. Specifically, in the drone training method, a plurality of discrete wind speed component values at equal intervals are generated within a specific wind speed component range. For example, assuming that a wind speed range on an X-axis is [−Xₙ, Xₚ], L discrete wind speed component values X₁, X₂, . . . , X_{L} are generated. Assuming that a wind speed range on a Y-axis is [−Yₙ,Yₚ], M discrete wind speed component values Y₁, Y₂, . . . , Y_{M} are generated. Assuming that a wind speed range on a Z-axis is [−Zₙ,Zₚ], N discrete wind speed component values Z₁, Z₂, . . . , Z_{N} are generated. An interval between the discrete wind speed component value X₁ and the discrete wind speed component value X₂ equals an interval between the discrete wind speed component value X₂ and the discrete wind speed component value X₃, also equals an interval between the discrete wind speed component value X_{L-1} and the discrete wind speed component value X_{L}, and so on. Then, in the drone training method, after the plurality of discrete wind speed component values are input into the regression model, a lookup table Tis generated and stored.

As shown in FIG. 9, in this embodiment, in the drone training method, each of the discrete wind speed component values X₁, X₂, . . . , X_{L} is used to replace the wind speed component value ω_{X} and input into the regression model, each of the discrete wind speed component values Y₁, Y₂, . . . , Y_{M} is used to replace the wind speed component value ω_{Y} and input into the regression model, each of the discrete wind speed component values Z₁, Z₂, . . . , Z_{N} is used to replace the wind speed component value ω_{Z} and input into the regression model, so that a compensation value C_{X} corresponding to the wind speed component ω_{X} can be generated. Therefore, a lookup table T including L×M×N compensation values is generated. Similarly, a compensation value C_{Y} corresponding to the wind speed component ω_{Y} and a compensation value C_{Z} corresponding to the wind speed component ω_{Z} can be generated. In some embodiments, as shown in FIG. 6, the lookup table T is used as a lookup table T in the drone control method. Similarly, in the drone training method, the foregoing steps can also be repeated to input discrete wind speed component values into other regression models to generate compensation values corresponding to other wind speed components, thereby generating lookup tables T corresponding to different wind speed components. As shown in FIG. 5, different lookup tables T are applied to different wind resistance controllers 2411, 2412, and 2413, to generate compensation value components u_{X}, u_{Y}, and u_{Z} to offset impact of wind speed components ω_{X}, ω_{Y}, and ω_{Z} on the drone 2.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A drone training method, applicable to a drone, wherein the drone comprises a wind speed sensor and a position sensor, and the drone training method comprises:
receiving a plurality of wind speed components generated by the wind speed sensor and a plurality of offset components generated by the position sensor, wherein the wind speed components correspond to the offset components one by one;
inputting each of the wind speed components into a corresponding plurality of fuzzy functions, to generate a plurality of wind speed membership values respectively;
selecting one from the plurality of wind speed membership values corresponding to each of the wind speed components, and generating a rule value based on the wind speed membership values corresponding to each of the wind speed components;
inputting the plurality of wind speed components into inference functions, wherein each rule value corresponds to one of the inference functions as a weight respectively, and calculating a function sum of a plurality of inference functions corresponding to each of the wind speed components; and
generating a regression model after calculating an error function base on each offset component and the function sum corresponding to each of the wind speed components and optimizing the error function.

2. The drone training method according to claim 1, wherein in the drone training method, a minimum value among the wind speed membership values corresponding to all the wind speed components is used as the rule value.

3. The drone training method according to claim 1, wherein in the drone training method, an accumulated product of the wind speed membership values corresponding to all the wind speed components is used as the rule value.

4. The drone training method according to claim 1, further comprising:
dividing the rule values by a sum of all the rule values, to normalize the rule values; and
inputting the plurality of wind speed components into the inference functions, wherein each normalized rule value corresponds to one of the inference functions as a weight respectively.

5. The drone training method according to claim 1, further comprising:
generating a plurality of discrete wind speed component values at equal intervals within a range of wind speed components; and
generating and storing a lookup table after inputting the plurality of discrete wind speed component values into the regression model.

6. The drone training method according to claim 5, further comprising: collecting statistics on the range of wind speed components based on the plurality of wind speed components generated by the wind speed sensor.

7. The drone training method according to claim 1, further comprising: generating the plurality of fuzzy functions at equal core intervals within a range of wind speed component.

8. The drone training method according to claim 1, wherein the inference function is a multivariate linear regression model function, comprising N regression coefficients and a bias value, wherein a value of N equals a quantity of the plurality of wind speed components.

9. The drone training method according to claim 1, further comprising: negating each offset component, generating the regression model after calculating the error function between the negated offset component and the function sum corresponding to the wind speed component, and optimizing the error function.

10. The drone training method according to claim 1, wherein the drone is configured to control the drone according to a plurality of motor control signals, and the drone training method further comprises:
re-receiving another plurality of wind speed components generated by the wind speed sensor;
generating a plurality of compensation values after inputting the another plurality of wind speed components into the regression model; and
correcting the plurality of motor control signals based on the plurality of compensation values respectively, and controlling the drone based on the plurality of corrected motor control signals.

11. The drone training method according to claim 1, further comprising: calculating the error function between the offset component and the function sum corresponding to the wind speed component according to the following formula:
$$e = \frac{1}{2} {( U - C )}^{2}$$
wherein e is the error function, U is one of the plurality of offset components, and C is the function sum corresponding to one of the wind speed components.

12. The drone training method according to claim 11, further comprising: optimizing the error function according to a gradient descent method, to obtain a model parameter of the regression model, wherein the model parameter is selected from a group comprising a regression coefficient of the inference function, a bias value of the inference function, a function type of the fuzzy function, a core position of the fuzzy function, a position of a left endpoint of the fuzzy function, a position of a right endpoint of the fuzzy function, and a combination thereof.

13. The drone training method according to claim 1, wherein the plurality of wind speed components are orthogonal to each other, and the plurality of offset components are orthogonal to each other.

14. A drone control method, for correcting a plurality of motor control signals, wherein the drone control method comprises:
reading a plurality of wind speed components and a plurality of lookup tables, wherein each of the lookup tables corresponds to one of the motor control signals, and each of the plurality of lookup tables comprises a regression model of a plurality of wind speed approximations and a compensation value;
inputting each of the wind speed components into one of corresponding nearest neighbor functions, to generate the plurality of wind speed approximations;
matching the plurality of wind speed approximations with the compensation values based on the corresponding lookup tables, to generate the compensation values; and
correcting each of the motor control signals based on the compensation values generated by the lookup tables.

15. The drone control method according to claim 14, wherein the nearest neighbor function comprises a plurality of discrete wind speed component values, and determining, among the plurality of discrete wind speed component values, the discrete wind speed component value closest to each of wind speed component input into the nearest neighbor function, to generate a wind speed approximation.

16. The drone control method according to claim 14, further comprising: receiving the plurality of wind speed components generated by a wind speed sensor, and respectively correcting each of the motor control signals based on the compensation values generated by the lookup tables, to control a plurality of motors respectively.

17. The drone control method according to claim 14, wherein the plurality of wind speed components are orthogonal to each other, and the compensation values generated by the lookup tables are orthogonal to each other.

18. A drone, comprising:
a wind speed sensor, configured to measure a wind speed value, comprising a plurality of wind speed components;
a memory, configured to store a plurality of lookup tables; and
a processor, configured to:
read a plurality of wind speed components and a plurality of lookup tables, wherein each of the lookup tables corresponds to one of the motor control signals, and each of the plurality of lookup tables comprises a regression model of a plurality of wind speed approximations and a compensation value;
input each of the wind speed components into one of corresponding nearest neighbor functions, to generate the plurality of wind speed approximations;
match the plurality of wind speed approximations with the compensation values based on the corresponding lookup tables, to generate the compensation values; and
correct each of the motor control signals based on the compensation values generated by the lookup tables.

19. The drone according to claim 18, further comprising a plurality of motors, wherein the processor is configured to control the plurality of motors based on the motor control signals.

20. The drone according to claim 18, wherein the wind speed sensor is selected from the group comprising a cup anemometer, a vane anemometer, a pressure tube anemometer, an ultrasonic anemometer, and a combination thereof.
